(19) United States
(12) Patent Application Publication
(10) Pub. No.: US 2024/0084910 A1
(43) Pub. Date: Mar. 14, 2024

(54) STEMLESS CHOKE VALVE

(71) Applicant: New Star Flow Control Ltd., Edmonton (CA)

(72) Inventors: Patrick WONG, Edmonton (CA); Abdul RACHIM, Edmonton (CA); Simeon HELFRICH, Edmonton (CA)

(21) Appl. No.: 18/467,476

(22) Filed: Sep. 14, 2023

Related U.S. Application Data
(60) Provisional application No. 63/406,473, filed on Sep. 14, 2022.

(51) Int. Cl. F16K 27/00; F16K 31/53

(52) U.S. Cl. CPC F16K 27/00; F16K 31/53

(57) ABSTRACT

A stemless valve includes (a) a valve body having a longitudinal axis and defining a central flow passage and an upper actuator opening; (b) a cylindrical rotator disposed within the central flow passage, and having a rotator gear exposed through the actuator opening, the rotator sealed within the valve body to prevent fluid flow outside the central flow passage; (c) an actuating element passing through the upper actuator opening, and having a actuating gear which engages the rotator gear. Movement of the actuating rod rotates the rotator around the longitudinal axis within the valve body, causing opening or closing of a variable orifice connected to the rotator.

### FIELD OF THE INVENTION

The present invention generally relates to a stemless choke valve having a variable orifice actuator and replaceable wear elements.

### BACKGROUND

Choke valves that handle oil and gas production fluids with suspended sand particles experience accelerated wear, and require frequent servicing and replacement.

There remains a need in the art for a valve that may be more conveniently adjustable, serviceable and/or replaceable.

### SUMMARY OF THE INVENTION

Disclosed herein are embodiments of a stemless valve. In one aspect, the invention comprises a valve comprising:
(a) a valve body having a longitudinal axis and defining a central flow passage and an upper actuator opening;
(b) a hollow cylindrical rotator disposed within the central flow passage, and having a rotator gear exposed through the actuator opening, the rotator sealed within the valve body to prevent fluid flow outside the central flow passage;
(c) an actuating element passing through the actuator opening and a actuating gear which engages the rotator gear, such that movement of the actuating element rotates the rotator around the longitudinal axis within the valve body;
(d) a variable orifice connected to the rotator, such that rotation of the rotator causes rotation of the variable orifice, to open or close the variable orifice.

In some embodiments, the actuating element is a rotating rod extending from the valve body at an angle from the longitudinal axis, which may be a 90 degree angle, and the first and actuating gears each comprise at least a portion of a bevel gear.

In some embodiments, the variable orifice comprises a fixed orifice plate defining at least one opening and a rotating orifice plate defining at least one opening, wherein the degree of overlap between the fixed and rotating orifice plates determines the state of the variable orifice.

In some embodiments, the valve body further defines a service opening, permitting installation and removal of the variable orifice. The valve may further comprise at least one replaceable wear element sleeve disposed within the valve body.

In some embodiments, a bonnet may be removably attached to the valve body to cover the actuator opening and/or the service opening.

### BRIEF DESCRIPTION OF THE FIGURES

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

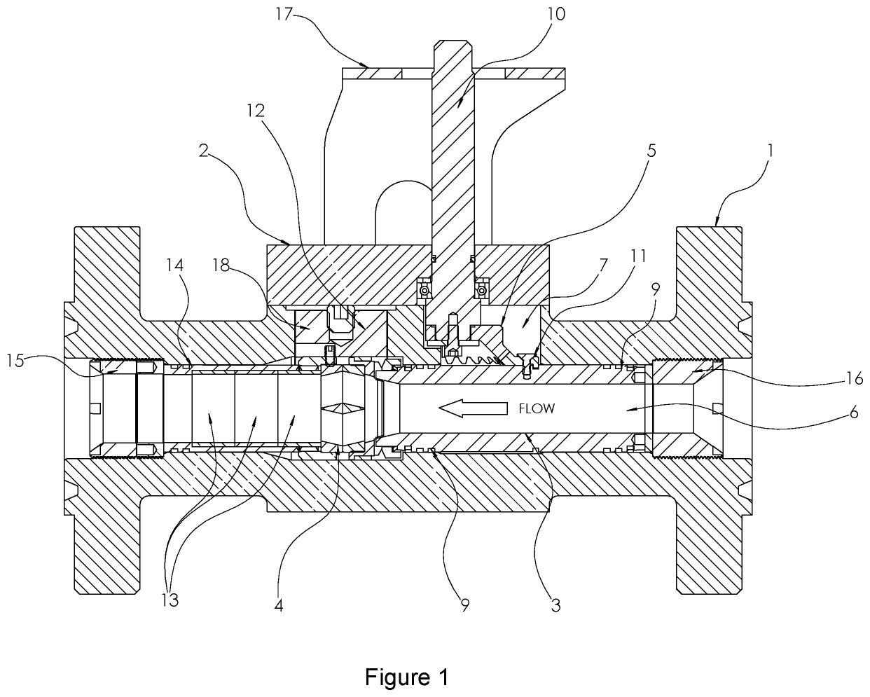

(a) FIG. 1 is a longitudinal cross-section of one embodiment of a choke valve of the present invention;

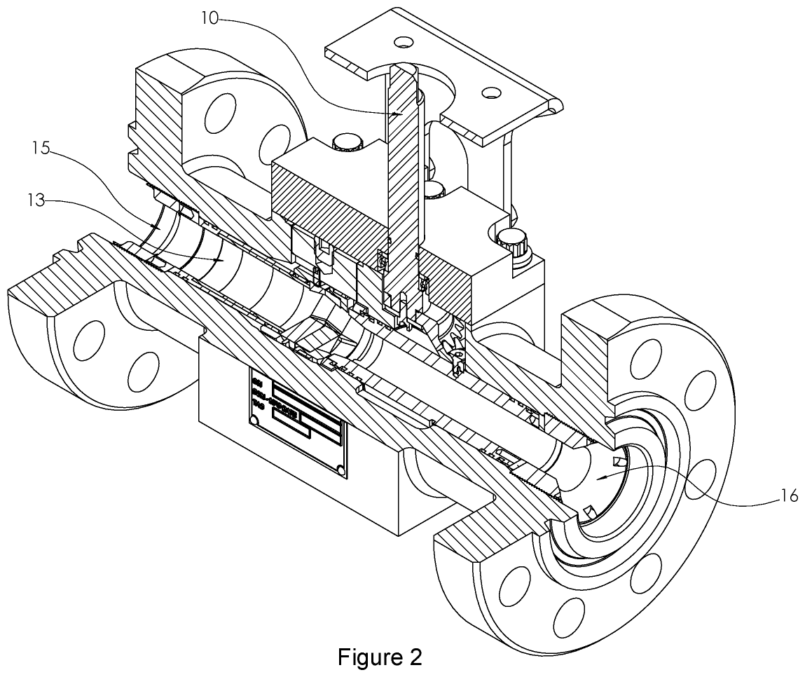

(b) FIG. 2 is a partial cutaway perspective view of the embodiment of FIG. 1.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The terms longitudinal, lateral, and transverse may be used to denote motion or spacing along three mutually perpendicular axes, wherein each of the axes defines two opposite directions. The directions defined by each axis may also be referred to as positive and negative directions. Additionally, the descriptions that follow may refer to the directions defined by the axes with specific reference to the orientations illustrated in the figures. For example, the directions may be referred to as distal/proximal, left/right, and/or up/down. It should be appreciated that such terms may be used simply for ease and convenience of description and, therefore, used without limiting the orientation of the system with respect to the environment unless stated expressly to the contrary. For example, descriptions that reference a longitudinal direction may be equally applicable to a vertical direction, a horizontal direction, or an off-axis orientation with respect to the environment. Furthermore, motion or spacing along a direction defined by one of the axes need not preclude motion or spacing along a direction defined by another of the axes. For example, elements described as being “laterally offset” from one another may also be offset in the longitudinal and/or transverse directions, or may be aligned in the longitudinal and/or transverse directions. The terms are therefore not to be construed as further limiting the scope of the subject matter described herein.

Conventional components of the invention are elements that are well-known in the prior art may not be discussed in detail for this disclosure.

FIGS. 1 and 2 respectively show a cross-section view and a perspective cutaway view of one embodiment of a stemless choke valve.

A valve comprises a valve body 1 having a longitudinal axis, attachment flanges or threaded connections at both ends, and which defines a central flow passage 6 and an upper actuator opening 7. A hollow cylindrical rotator 3 is disposed within the central flow passage and has a rotator gear 8 exposed through the actuator opening 7. The rotator 3 is sealed within the valve body 1 with O-ring seals 9 to prevent fluid flow outside the central flow passage.

An actuating rod 10 is positioned adjacent the actuator opening 7 and has an actuating gear 11 which engages the rotator gear 8, such that rotation of the actuating rod 10 rotates the rotator 3 around the longitudinal axis within the valve body. In some embodiments, the actuating rod extends from the valve body 1 at an angle, which may be a 90 degree angle, and the rotator gear and actuating gear 8, 11 each comprise at least a portion of a bevel gear.

A variable orifice 4 is connected to the rotator 3, such that rotation of the rotator 3 causes rotation of the variable orifice 4 to open or close the variable orifice. In some embodiments, the variable orifice comprises a fixed orifice plate, orientated transversely and defining at least one opening and a rotating orifice plate engaging the fixed orifice plate and defining at least one opening. Where the fixed opening and the rotating opening are not aligned, no flow may pass through the variable orifice 4. The degree of overlap between the fixed and rotating plate orifices determines the open, partly open, or closed state of the variable orifice.

In some embodiments, the valve body further defines a service opening 12 covered with a removeable cover plate 18, permitting installation and removal of the variable orifice 4 components laterally through the valve body 1. In some embodiments, a bonnet 2 may be removably attached to the valve body 1 to cover the actuator opening 7 and/or the service opening 12.

The valve may further comprise at least one replaceable wear sleeve 13 disposed within the valve body 1 to contain the flow stream. The wear sleeves may be disposed in a cylindrical carrier 14, positioned immediately downstream from the variable orifice 4, positioned where significant erosion may take place due to turbulent flow induced by the orifice. In some embodiments, there are two or more wear sleeves 13 which can be removed and replaced through the service opening—. The carrier 14 abuts the orifice 4 and is retained by a lock nut 15 which is threaded into the valve body 1.

At the intake end, a flow centralizer 16 is also threaded into the valve body, and retains the rotating member 3 within the valve body 1.

A bracket 17 may be provided and mounted to the valve body 1 or bonnet 2, for facilitating the installation of a valve actuator (not shown), which may rotate the actuation rod 10, permitting remote actuation.

As one skilled in the art will appreciate, the components of this choke valve which may be subject to erosion may be manufactured from tungsten carbide, or another material highly resistant to erosion.

As one skilled in the art will appreciate, this configuration may be considered “stemless” as the valve stem or actuation rod 10 is wholly outside the pressure zone within the valve body 1, which pressure zone is contained entirely within the rotator 3, variable orifice 4, and wear sleeve carrier 14. The rotator 3 is contained within the valve body 1 and cannot accidently come out of the flow passage 6. The gear mechanism 8, 11 and the actuation rod 10 are fully outside the fluid flow and pressure.

### Exemplary Aspects

In view of the described devices, systems, and methods and variations thereof, certain more particularly described aspects of the invention are presented below. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A stemless valve comprising:
(a) a valve body having a longitudinal axis and defining a central flow passage and an upper actuator opening;
(b) a cylindrical rotator disposed within the central flow passage, and having a rotator gear exposed through the actuator opening, the rotator sealed within the valve body to prevent fluid flow outside the central flow passage;
(c) an actuating element passing through the upper actuator opening, and having a actuating gear which engages the rotator gear, such that movement of the actuating rod rotates the rotator around the longitudinal axis within the valve body;
(d) a variable orifice connected to the rotator, such that rotation of the rotator causes rotation of the variable orifice to open or close, or partially open the variable orifice.

Aspect 2: The valve of aspect 1, wherein the actuating element is a rotating rod extending from the valve body at an angle, which may be a 90 degree angle, and the first and actuating gears comprise at least a portion of a bevel gear.

Aspect 3: The valve of aspect 1 or 2, wherein the variable orifice comprises a fixed orifice plate defining at least one opening and a rotating orifice plate defining at least one opening, wherein the degree of overlap between the fixed and rotating plates determines the state of the variable orifice.

Aspect 4: The valve of any one of aspects 1-3, wherein the valve body further defines a service opening, permitting installation and removal of the variable orifice.

Aspect 5: The valve of any one of aspects 1-4, further comprising at least one replaceable wear element sleeve disposed within the valve body.

Aspect 6: The valve of any one of aspects 1-5, further comprising a bonnet which is removably attached to the valve body to cover the actuator opening and/or the service opening.

Aspect 7. A valve comprising any combination of elements or features described individually or in combination herein, and/or omitting any one or more elements or features described herein.

### Interpretation.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

What is claimed is:

1. A stemless valve comprising:
(a) a valve body having a longitudinal axis and defining a central flow passage and an upper actuator opening;
(b) a cylindrical rotator disposed within the central flow passage, and having a rotator gear exposed through the actuator opening, the rotator sealed within the valve body to prevent fluid flow outside the central flow passage;
(c) an actuating element passing through the upper actuator opening, and having a actuating gear which engages the rotator gear, such that movement of the actuating rod rotates the rotator around the longitudinal axis within the valve body;
(d) a variable orifice connected to the rotator, such that rotation of the rotator causes rotation of the variable orifice to open or close, or partially open the variable orifice.

2. The valve of claim 1, wherein the actuating element is a rotating rod extending from the valve body at an angle, and the first and actuating gears comprise at least a portion of a bevel gear.

3. The valve of claim 2, wherein the actuating element extends from the valve body at a 90° angle.

4. The valve of claim 1, wherein the variable orifice comprises a fixed orifice plate defining at least one opening and a rotating orifice plate defining at least one opening, wherein the degree of overlap between the fixed and rotating plate orifices determines the state of the variable orifice.

5. The valve of claim 1, wherein the valve body further defines a service opening, permitting installation and removal of the variable orifice.

6. The valve of claim 1, further comprising at least one replaceable wear element sleeve disposed within the valve body.

7. The valve of claim 6 wherein the at least one replaceable wear element sleeve is accessible through the service opening.

8. The valve of claim 5, further comprising a bonnet which is removably attached to the valve body to cover the actuator opening and/or the service opening.

9. The valve of claim 1, wherein the rotator and variable orifice define a high pressure zone, and the actuation rod is wholly outside the high pressure zone.

10. The valve of claim 1 wherein the rotator and variable orifice are wholly contained within the valve body, and can only be removed through an end of the valve body.
